(19) United States
(12) Patent Application Publication
(10) Pub. No.: US 2003/0235164 A1
(43) Pub. Date: Dec. 25, 2003

(54) Management of location-aware networks

(75) Inventors: Christopher B. Rogers, Beaverton, OR (US); Stephen R. Wood, Beaverton, OR (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 10/178,880

(22) Filed: Jun. 24, 2002

(51) Int. Cl. H04Q 7/00; H04Q 7/24

(52) U.S. Cl. 370/331; 370/338

(57) ABSTRACT

A network may determine the location of network nodes, create coverage maps, and perform predictive transitions between network access points.

### BACKGROUND

Wireless local area networks (WLANs), wireless wide area networks (WWANs), and cellular telephone networks have similar problems when a mobile user (or “node”) transitions from one cell to another. For example, potentially problematic transitions occur when mobile network nodes approach the fringes of coverage for a given cell and initiate a protocol for negotiating a hand-off to a neighboring cell. In the case of WLANs, this handoff is referred to as “re-association” between a node and a fixed network access point. The problem of negotiating the transition can become more problematic as the speed of movement of the node increases, the bandwidth requirements of the data increase, the acceptable latency time frames decrease, or complicated internetwork transitions are involved, as in transitioning from a WLAN to a WWAN.

For the reasons stated above, and for other reasons stated below which will become apparent to those skilled in the art upon reading and understanding the present specification, there is a need in the art for alternate methods and apparatus for wireless networks.

### BRIEF DESCRIPTION OF THE DRAWINGS

FIG. 1 shows a diagram of a wireless network;

FIG. 2 shows a diagram of a network access point device;

FIG. 3 shows a diagram of a network server;

FIG. 4 shows a diagram of mobile user movement in a wireless network;

FIG. 5 shows a data table having coverage map information;

FIG. 6 shows a flowchart of a method for generating a coverage map;

FIG. 7 shows another diagram of mobile user movement in a wireless network; and

FIG. 8 shows a flowchart of a method for determining a network access point to communicate with a mobile user.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

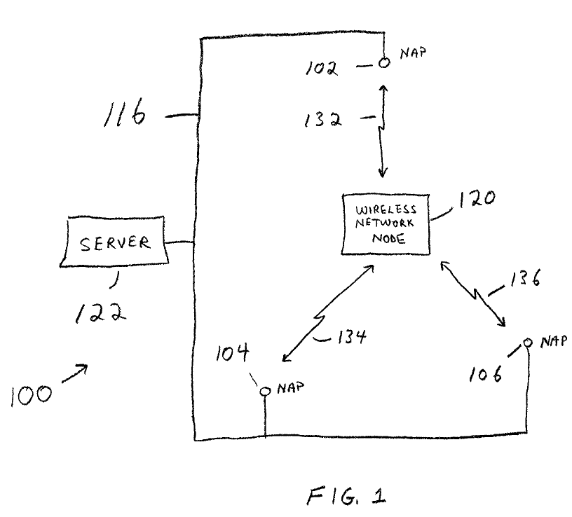

FIG. 1 shows a diagram of a wireless network. Network 100 includes server 122, network access points (NAPs) 102, 104, and 106, and wireless network node 120. Access points 102, 104, and 106 are coupled to server 122 by media 116, and one or more of access points 102, 104, and 106 are coupled to node 120 by wireless links 132, 134, and 136. The combination of access points 102, 104, and 106, and server 122 provide network services to network node 120. In addition, node 120 may, in some embodiments, provide network services to other nodes (not shown), or to any of access points 102, 104, and 106.

Wireless network 100 may be any type of network that allows a node to access network services using a wireless link. For example, in some embodiments of the present invention, wireless network 100 represents a cellular telephone network, and in other embodiments, wireless network 100 represents a wireless local area network (WLAN) or wireless wide area network (WWAN). In still further embodiments, network 100 is a hybrid system that provides a combination of different services to network nodes and access points. Media 116 may be any type of signal transmission media capable of providing a data communication path between server 122 and access points 102, 104, and 106. Examples include, but are not limited to: wires, fiber optic cables, and wireless links.

Wireless network node 120 may be any type of network node capable of accessing network services using a wireless link. For example, node 120 may be a cellular telephone, a computer, a personal digital assistant (PDA), or any other type of device that may access a network using a wireless link. In some embodiments, node 120 may be a combination cellular phone and computer that provides both wireless data and voice services.

In general, nodes and access points are network elements that may provide network services, receive network services, or both. For example, in cellular network embodiments, access points 102, 104, and 106 may be cellular base stations that provide network services, and node 120 may be a cellular telephone that primarily receives network services. Also for example, in wireless LAN embodiments, node 120 and access points 102, 104, and 106 may be computers that provide and receive network services. The remainder of this description describes many different embodiments of the present invention, with an emphasis on wireless LAN embodiments. The emphasis on wireless LAN embodiments is provided for clarity, and one of ordinary skill in the art will understand that embodiments of the present invention are not limited to wireless LANs.

In operation, network 100 provides the ability to determine the location of wireless network nodes. Throughout this description, this ability is referred to as “location determination.” Networks that provide location determination are referred to herein as “location-aware networks.” Network 100 is a location-aware network that provides location determination of node 120 through the use of wireless links 132, 134, and 136.

Wireless links 132, 134, and 136 provide communication paths between node 120 and access points 102, 104, and 106. The various access points send and receive wireless signals to and from node 120 on the wireless links, and also send and receive signals to and from server 122 using media 116. In some embodiments, wireless links 132, 134, and 136 utilize a pulse-based radio frequency (RF) protocol to provide communications between node 120 and access points 102, 104, and 106. In these embodiments, short RF pulses are transmitted by node 120 and received by access points 102, 104, and 106. In other embodiments, the wireless links utilize baseband modulated protocols in which the desired data to be transmitted is superimposed by various means on a sinusoidal carrier signal. One example of a suitable pulse-based protocol is the emerging ultra-wideband (UWB) protocol in which low power, short duration, pulses are transmitted over the wireless link. Another example of a suitable pulse-based protocol is described in U.S. Pat. No. 6,031,862, issued to Fullerton et al. on Feb. 29, 2000. In other embodiments, wireless links 132, 134, and 136 utilize a data modulated sinusoidal carrier. Any type of wireless protocol maybe utilized for wireless links 132, 134, and 136.

Any type of information may be contained within the signals received from node 120. For example, the signals may contain voice information or data information, in any analog or digital format suitable for requesting or providing network services.

When receiving wireless signals from node 120, the various access points may also gather information describing attributes of the wireless signals. For example, in pulse-based embodiments, the access points may gather pulse time-of-arrival information as well as angle-of-arrival, pulse amplitude, pulse duration, and rise/fall time information. In sinusoidal carrier embodiments, the access points may gather angle-of-arrival, center frequency, amplitude, phase offset, or other information. In general, information gathered describing attributes of the received signals may include any type of information, including information suitable to support location determination. For example, pulse time-of-arrival information or angle-of-arrival information, or both, may be used to determine the location of network node 120 relative to the locations of the access points. Also for example, phase offset of a received sinusoidal carrier signal may also be used in support of location determination.

Attributes of received wireless signals may be transmitted from the various access points to server 122. These attributes may then be used by server 122 to determine the location of node 120. For example, in pulse-based embodiments, pulse time-of-arrival information gathered by the access points may be used to resolve the position of node 120 relative to the locations of the access points that measure the time-of-arrival. Also for example, in sinusoidal carrier embodiments, phase offsets may be used to resolve the location of node 120.

Attributes of wireless signals may also be used to determine one or more metrics that describe “signal quality.” Signal quality may be represented by any of many possible metrics including, for example, pulse amplitude, average signal strength, timing jitter, phase noise, frequency offsets or data rate. Signal quality, and various uses thereof, are described in more detail with reference to the figures that follow.

FIG. 1 shows three access points. In embodiments with three access points capable of receiving signals from node 120, the location of node 120 may be determined in two dimensions. Some embodiments have more than three access points. In embodiments with four or more access points capable of receiving signals from node 120, the location of node 120 may be determined in three dimensions.

Some embodiments use fewer than three access points, and sometimes in combination with other information about the operating environment, to resolve location. For example, in embodiments with two access points, wireless networks that measure angle-of-arrival of signals may resolve the location of node 120 in two dimensions. In embodiments with two access points that measure time-of-arrival, the network may resolve the location of node 120 to be one of two possibilities. When this information is combined with other information about the operating environment, such as the boundaries of a building, one of the two possibilities can be chosen as the location of node 120.

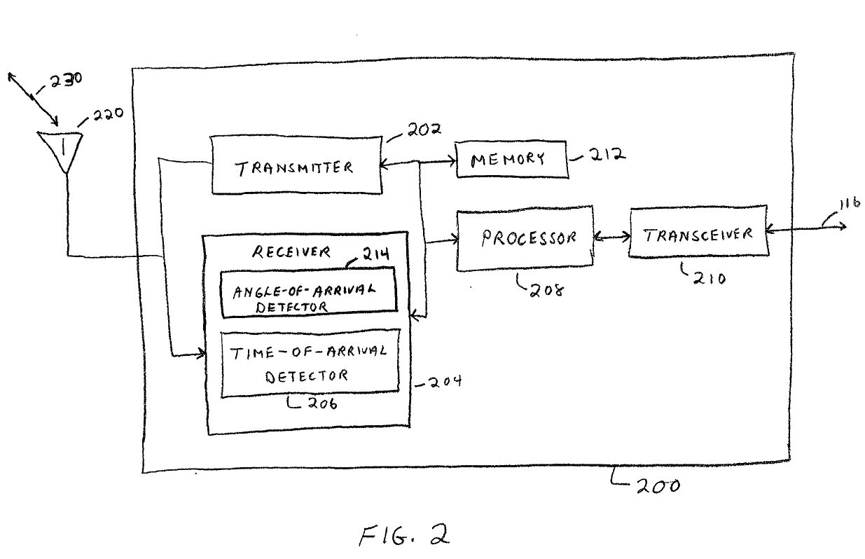

FIG. 2 shows a diagram of a network access point device suitable for use at the network access points shown in FIG. 1. Network access point device 200 includes transmitter 202, receiver 204, time-of-arrival detector 206, angle-of-arrival detector 214, processor 208, memory 212, and transceiver 210. Transceiver 210 communicates with a server (not shown) using media 116. Transceiver 210 also communicates with processor 208. Transmitter 202 and receiver 204 both communicate with processor 208 and antenna 220.

Antenna 220 receives wireless signals from network nodes on wireless link 230. In some embodiments, wireless signals on wireless link 230 include electromagnetic pulses as described above with reference to FIG. 1. In some of these embodiments, receiver 204 receives the pulses, and time-of-arrival detector 206 detects the arrival time of the pulse. Time-of-arrival information is one of many possible attributes of a wireless signal that may be measured by receiver 204. For example, in some embodiments, angle-of-arrival detector 214 detects the angle from which the pulse arrived as an attribute of the wireless signal. Some embodiments measure both time-of-arrival and angle-of-arrival. Processor 208 receives information describing the wireless signal from receiver 204 and provides it to a network server using transceiver 210.

Time-of-arrival detector 206 can be implemented in a number of different ways. In one embodiment, the function of the time-of-arrival detector is a separate module within network access point device 200. In another embodiment, time-of-arrival detector 206 may be integrated into receiver 204. In yet another embodiment, time-of-arrival detector 206 may utilize processing capabilities of processor 208 to perform its function.

Angle-of-arrival detector 214 can also be implemented in a number of different ways. In some embodiments, angle-of-arrival detector 214 is a circuit that receives signals from a phased array antenna to measure the angle from which the signals are received. In these embodiments, antenna 220 represents a phased array antenna. Many other mechanisms can be used to measure the angle-of-arrival of the wireless signal.

Processor 208 may be any type of processor suitable to perform actions to support the operation of network access point device 200. For example, processor 208 may be a microprocessor, a microcontroller, or the like. Also for example, processor 208 may be a hardware controller or a collection of hardware controllers that perform specific tasks. Memory 212 represents an article that includes a machine-accessible medium. For example, memory 212 may represent any one or more of the following: a hard disk, a floppy disk, random access memory (RAM), read only memory (ROM), flash memory, CDROM, or any other type of article that includes a medium readable by a machine. Memory 212 may store instructions for performing the execution of the various method embodiments of the present invention. Memory 212 may also include data describing the current state of network access point device 200 and the entire network.

When multiple network access point devices 200 measure attributes of a single electromagnetic pulse, a network server may utilize this information to resolve the location of the network node from which the pulse originated. In some embodiments, multiple electromagnetic pulses are received by receiver 204. The multiple electromagnetic pulses may represent any type of communication from a network node. For example, a group of pulses may represent a request from a network node to re-associate with a different network access point. Also for example, a group of pulses may represent a different data communication from a network node. Receiver 204 derives information from groups of pulses, as well as from attributes describing the pulses. Processor 208 receives from receiver 204 information describing both groups of pulses as well as attributes of individual pulses. For example, processor 208 may receive data from a network node, as well as receiving time-of-arrival and angle-of-arrival information of pulses received by receiver 204.

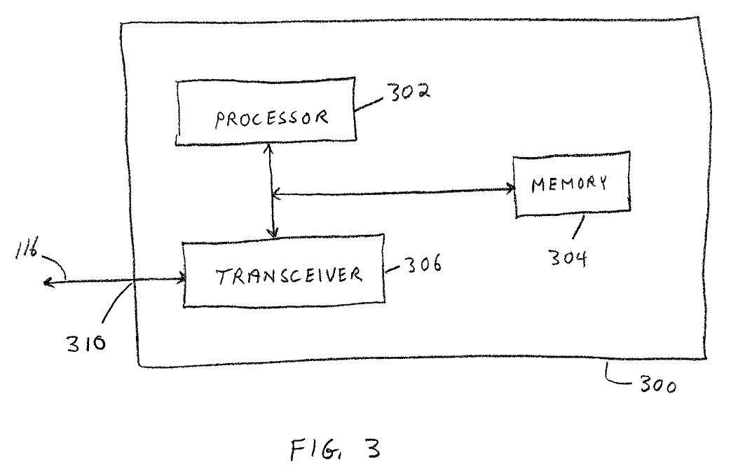

FIG. 3 shows a diagram of a network server suitable for use in a wireless network such as network 100 (FIG. 1). Server 300 includes processor 302, memory 304, and transceiver 306. Transceiver 306 is coupled to media 116 at port 310. As described above with reference to FIG. 1, media 116 couples the network server with any number of network access point devices such as network access point device 200 (FIG. 2). Transceiver 306 receives information from network access point devices on media 116. In some embodiments, wireless signal attributes are received from multiple network access point devices, and processor 302 determines the location of a transmitter from which the wireless signals originated. Server 300 may be a personal computer (PC), server, mainframe, handheld device, portable computer, or any other system that may perform the operations described herein.

Memory 304 represents an article that includes a machine-accessible medium. For example, memory 304 may represent any one or more of the following: a hard disk, a floppy disk, random access memory (RAM), read only memory (ROM), flash memory, CDROM, or any other type of article that includes a medium readable by a machine. Memory 304 may store instructions for performing the execution of the various method embodiments of the present invention. Memory 304 may also include data describing the current state of server 300 and the entire network. For example, memory 304 may include data describing a coverage map, as well as the location of network nodes.

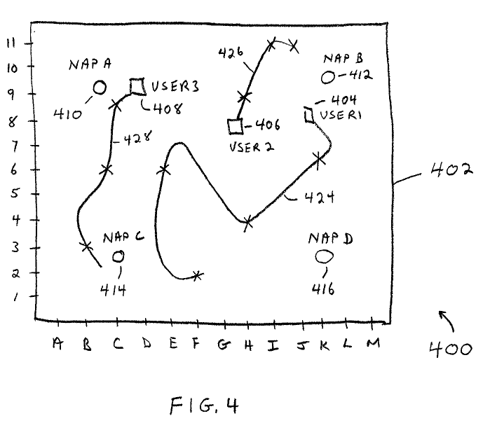

FIG. 4 shows a diagram of mobile user movement in a wireless network. Network 400 includes network access points 410, 412, 414, and 416, also shown as NAP A, NAP B, NAP C, and NAP D, respectively. Network 400 also includes mobile nodes 404, 406, and 408, also shown as USER 1, USER 2, and USER 3, respectively. Network 400 also includes at least one server (not shown), such as server 122 (FIG. 1) or server 300 (FIG. 3). Network 400 is bounded by boundary 402. The area within boundary 402 is referred to as the “network area.” The network area may be logically divided into discrete areas, forming a “location grid.” For example, boundary 402 has number and letter designations along two sides to generate a location grid. Boundary 402 may correspond to a building outline, but this is not necessary. For clarity, boundary 402 is shown in the shape of a square, but this is also not necessary. Any shape boundary, and therefore, any shape network area, can exist.

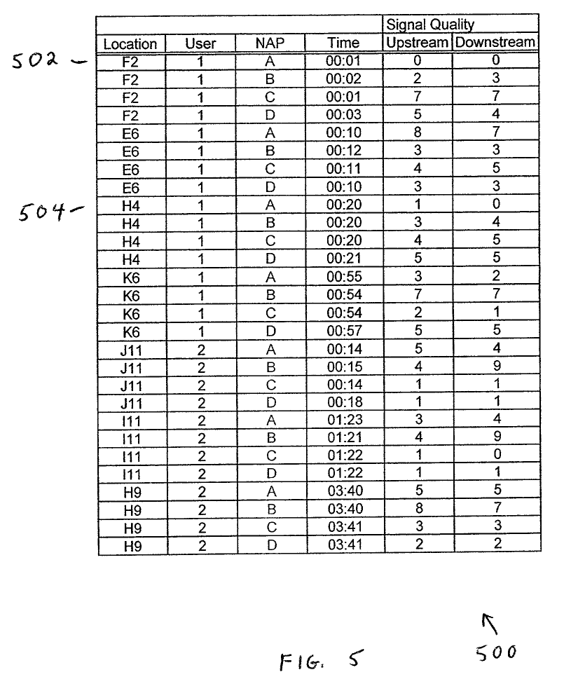

The user movements shown in FIG. 4 may be used to generate a coverage map of the network area. For example, as each user moves about the network area, the location of the user is determined periodically by the network as explained above with reference to the previous figures. Each user also records the signal quality of signals received from each network access point. The signal quality information is sent from the user to the network, where it is correlated with the location of the user node, thereby generating a coverage map of user-received signal quality for each network access point. Additionally, each network access point, upon receiving signals from a particular user, can also assess the signal quality of the user-transmitted signal. The information pertaining to the quality of this signal can also be correlated with the location of the user node. Thus, for each user node location and each network access point, the network can maintain information on both the “downstream signal quality” to the user node as well as the “upstream signal quality” from the user node back to the network access point. One such coverage map is shown in FIG. 5, and described below with reference thereto.

Continuing with the discussion of FIG. 4, each mobile node is shown with a “tail” that designates the movement of each user. For example, nodes 404, 406, and 408 are shown with tails 424, 426, and 428, respectively. Each tail includes “coverage map points” marked with an “X” to designate points where the coverage map is updated. For example, tail 424 has coverage map points at locations F2, E6, H4, and K6; tail 426 has coverage map points at locations J11, I11, and H9; and tail 428 has coverage map points at locations B3, C6, and C9.

In some embodiments, each user node reports the signal quality received from each network access point while at each coverage map point. By using the movement of users to develop a coverage map, network 400 obviates the need for dedicated personnel for coverage map generation, although dedicated personnel may still be used. In some embodiments, the coverage map is continuously updated as the users move about the network area. In these embodiments, near real-time changes in coverage may be reflected in the coverage map. For example, if a wall or other obstructing material is placed or moved within the network area, the coverage map may be affected. By using user nodes to maintain the coverage map, these changes can be quickly reflected in the coverage map.

In some embodiments, the network access point also records the signal quality received from each user node while at each coverage map point. By using the combination of upstream and downstream signal quality information at each coverage map point, problems associated with the receiver or transmitter of the network access point or user node can be flagged in near real time, reducing the support burden of maintaining proper operation of the wireless network.

FIG. 5 shows a data table having coverage map information. Data table 500 represents a coverage map generated from the movements of USERs 1 and 2 shown in FIG. 4. Each row in data table 500 corresponds to a single coverage map point shown with an “X” in FIG. 4. Data table 500 includes six columns: one for the coverage map point location in the grid, one for the user node, one for the network access point, one for the time the signal was acquired, and two for the recorded signal quality upstream and downstream. The first four rows in the table correspond to the first coverage map point shown on tail 424 (FIG. 4), with each of these first four rows corresponding to one of the four network access points A, B, C, or D. The next twelve rows correspond to the four network access points for each of three more coverage map points shown on tail 424 (FIG. 4). The next nine rows correspond to the three coverage map points shown on tail 426. For clarity, only 16 rows are shown in data table 500. In some embodiments many more rows are present. For example, data table 500 may have one row entry for each grid location, or may have multiple row entries for each grid location.

The numbers entered in the signal quality columns are integers from zero to nine, with zero representing no signal present and nine representing a very high quality signal present. When a user node is in close proximity to a network access point a high quality signal is generally received due to high signal strength, and when a user node is far away from a network access point, a lower quality signal may be received. In addition to distance from a network access point, obstructions in the network area can influence the quality of the signal received.

The various embodiments of the invention may discover blind spots or “shadows” in the coverage map. For example, referring now to row 502, USER 1 does not receive a signal from NAP A at location F2 as evidenced by the zero entered in the downstream column. This corresponds to a shadow in the coverage map for NAP A at grid location F2. In addition, a zero is entered in the upstream column for NAP A at grid location F2, signifying that no signal was received by NAP A from USER 1. In this example, neither USER 1 nor NAP A was able to communicate with the other while USER 1 was at grid location F2. Referring now to row 504, downstream signal quality is zero, and upstream signal quality is one between USER 1 and NAP A at grid location H4. In this example, USER 1 does not receive a signal from NAP A, but NAP A does receive a signal from USER 1, albeit a signal of low quality.

Data table 500 may be used as a coverage map in the form shown, or it may be reformatted or combined with other information. For example, in some embodiments, data table 500 includes current loading information for each network access point. The data in data table 500 may be graphically presented on a screen for network managers to view, or may be printed in a report, graphically, tabular, or otherwise.

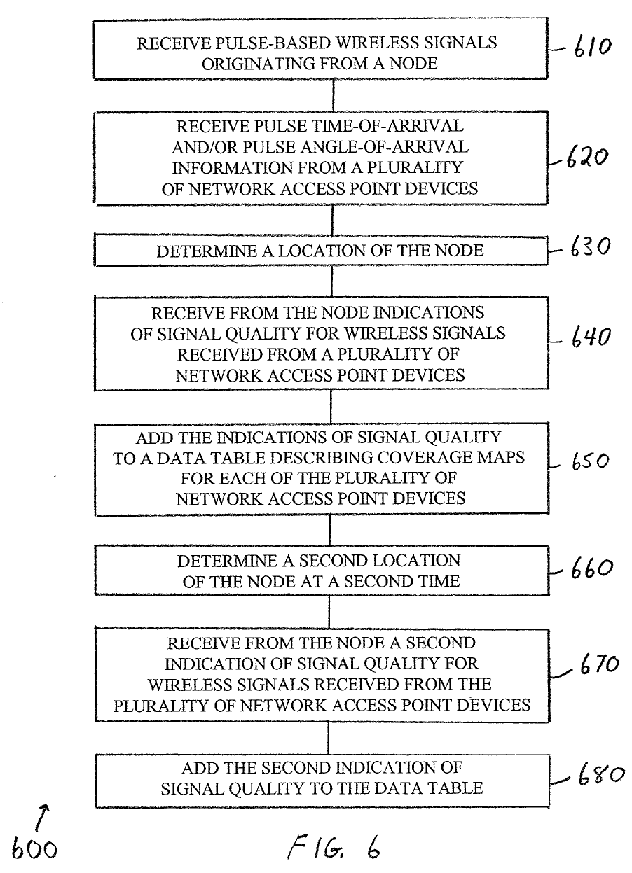

FIG. 6 shows a flowchart of a method for generating a coverage map. In some embodiments, method 600 is performed by a server such as server 300 (FIG. 3). In other embodiments, method 600 is distributed across a server and network access point devices. The various actions in method 600 may be performed in the order presented, or may be performed in a different order. Further, in some embodiments, some actions listed in FIG. 6 are omitted from method 600.

Referring now to FIG. 6, a pulse-based wireless signal that originates from a node is received (block 610). In some embodiments the pulse-based wireless signal includes a series of electromagnetic pulses. The node corresponds to a network node, such as those shown in the previous figures, that is either stationary or moving about the network area. The network node may be accessing the network using a single network access point, and the wireless signal transmitted by the node may be received by multiple network access point devices.

Time-of-arrival information or angle-of-arrival information, or both, may be received from a plurality of network access point devices (block 620). The time-of-arrival or angle-of arrival information received may describe multiple electromagnetic pulses from the network node, or may describe a single electromagnetic pulse. At 630, the location of the node is resolved from the time-of-arrival or angle-of-arrival information. For example, the node location may be triangulated from time-of-arrival information from three or more network access point devices, or the node location may be resolved from angle-of-arrival information from two or more network access point devices, or the node location may be resolved from a combination of time or angle-of-arrival information. At 640, indications of signal quality for wireless signals are received from the node. These signal quality indications correspond to the quality of wireless signals transmitted from various network access points and received by the node. As described above, signal quality indications may take many forms. In some embodiments, the signal quality indication corresponds to the strength of the received signal. Then, at 650, the indications of signal quality are added to a data table describing coverage maps for the various network access point devices.

Method 600, as described thus far, produces at least one row in a coverage map such as data table 500 (FIG. 5). For example, referring to row 502 (FIG. 5), the location of the node referred to in block 630 corresponds to a grid location in the network area (F2), and the signal quality indications referred to in blocks 640 and 650 correspond to the signal quality indications given for upstream and downstream communications between network access points NAP A and mobile node 404 (USER 1).

Actions shown in blocks 660, 670, and 680 determine a location of the node at a second time, receive another set of signal quality indications, and add them to the data table. This corresponds to the entry of another row of a data table useful for a coverage map. These actions of method 600 may be repeated continuously for each node in the network. This may result is a continuously updated coverage map of the network area.

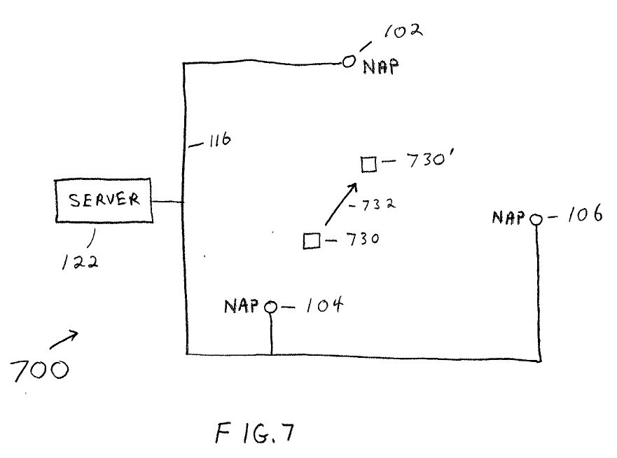

FIG. 7 shows another diagram of mobile user movement in a wireless network. Network 700 includes server 122, network access points 102, 104, and 106, and network node 730. Network node 730′ is the same node as network node 730, but at a later time. Arrow 732 shows the direction of travel during the time between node 730 and 730′.

Node 730 communicates with network 700 using network access point 104, and then moves away from network access point 104 as shown by arrow 732. As described above with reference to earlier figures, server 122 determines the location of node 730 as it moves about the network area. As a result, server 122 has information regarding the location of network node 730 as it changes from node 730 to 730′. In addition to location information, server 122 may also have velocity (also referred to as “rate”) information describing the movement of node 730. Velocity information may be generated in many different ways. For example, the location of the node can be determined at two different times, and then the velocity may be computed. Also for example, a Doppler shift of signals can be utilized to determine velocity.

As node 730 moves away from network access point 104 and moves toward network access point 102, node 730 will begin to lose the wireless signal from network access point 104. Server 122 may detect this condition and determine which of the other network access points is suitable to communicate with node 730. Server 122 may make this determination using a variety of information. For example, server 122 has access to the location and velocity of network node 730, as well as coverage map information such as that shown in FIG. 5. Server 122 also has access to information describing the loading of the various network access points. Server 122 may utilize all of this information and more when determining which network access point to connect to node 730.

As node 730′ moves away from network access point 104, it moves closer to network access point 102 than to network access point 106. In some embodiments, the coverage map may indicate that although network access point 102 has a higher signal quality, it also has a shadow in the path of node 730′. In these embodiments, server 122 may determine that node 730 should connect to network access point 106 instead of network access point 102. In other embodiments, the current load on the various network access points may be utilized to aid in the decision. For example, if network access point 102 has a high current load, and network access point 106 has a lower current load, then server 122 may determine that node 730′ should connect to node 106. In addition to current load conditions, server 122 may also weigh the expected bandwidth requirements of node 730′. In general, any information may be utilized by server 122 when determining which network access point to connect to the mobile user nodes.

In some embodiments, server 122 may track the location of node 730 and begin the process of transitioning the node to a different network access point in a predictive manner. In these embodiments, server 122 may use the velocity of node 730 to determine how soon to predict which network access point is appropriate. As the velocity of the node increases, server 122 may begin the predictive process sooner. In other embodiments, the process is less predictive. In these embodiments, server 122 waits until the network node is near the fringes of the coverage area of the current network access point before initiating the process of determining an appropriate new network access point to which the node should connect.

In some embodiments, server 122 dictates the network access point to which each mobile node connects, and sends this information to the appropriate mobile node. In other embodiments, server 122 identifies a number of appropriate network access points, and allows the mobile node to make the actual decision as to which network access node to access. In these embodiments, server 122 may send a prioritized list of appropriate network access points to the mobile node as a result of the predictive process described above.

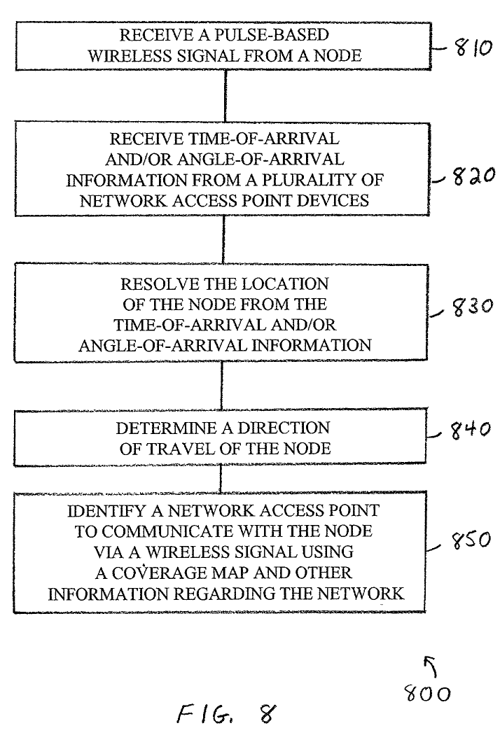

FIG. 8 shows a flowchart of a method for determining a network access point to communicate with a mobile user. Method 800, like method 600 (FIG. 6) may be performed by a server, such as server 122 (FIGS. 1, 7), or may be performed in a distributed manner by a plurality of network elements. For example, some portions of method 800 may be performed by server 122, and other portions may be performed by network access points such as network access points 102, 104, and 106 (FIGS. 1, 7). Additionally, in some embodiments, portions of the method are omitted, and in other embodiments, certain actions are performed in an order different than that shown in the figures.

Referring now to FIG. 8, a pulse-based wireless signal is received from a node (block 810). At 820, time-of-arrival information or angle-of-arrival information, or both, is received from a plurality of network access point devices. At 830, the location of the node is resolved from the time-of-arrival or angle-of-arrival information or both as discussed with reference to previous figures. At this point in method 800, the network has performed location determination, and has information describing the location of the node. Referring now back to FIG. 7, server 122 may perform the actions of method 800 described thus far to determine the location of node 730. Further, server 122 may, at a later time, determine the location of node 730′.

Referring now back to FIG. 8, a direction of travel of the node is determined at 840. This may be performed by determining the location at multiple points in time and examining the movement of the node. At 850, a network access point is selected to communicate with the node. In some embodiments, a particular network access point is identified, and in other embodiments, a list of suitable network access points are identified, and node is free to select from the list. When making the selection, a coverage map and any other information regarding the network may be used. For example, a data table such as data table 500 (FIG. 5) may be referred to when determining which network access points to select. Also for example, current loading information or velocity information may also be used during the selection process.

Any criteria that may affect the performance delivered to the network node may be used when selecting network access points. For example, in some embodiments, mobile user privilege levels may be set and utilized when determining which network access point to communicate with. In these embodiments, mobile users with higher privilege may be allowed to more easily connect with a network access point with more available bandwidth. In other embodiments, mobile users are connected to the nearest network access point with the lightest current load.

The various embodiments of the present invention may be utilized to negotiate a transition of a mobile device between neighboring network access points in a LAN, between a LAN and a WAN, between cells in a cellular network, or between any other type of access points in a location-aware network.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
determining a location of a network node;
determining a direction of travel of the network node; and
identifying a network access point to communicate with the network node via a wireless signal.

2. The method of claim 1 further comprising determining a rate of travel of the network node.

3. The method of claim 1 wherein determining the location of the network node comprises:
receiving time-of-arrival information from a plurality of network access point devices; and
resolving the location of the network node from the time-of-arrival information.

4. The method of claim 1 wherein determining the location of the network node comprises:
receiving angle-of-arrival information from a plurality of network access point devices; and
resolving the location of the network node from the angle-of-arrival information.

5. The method of claim 1 wherein determining a location of the network node comprises receiving a wireless signal from the network node.

6. The method of claim 5 wherein receiving the wireless signal comprises receiving a series of electromagnetic pulses.

7. The method of claim 6 wherein determining the location of the network node further comprises receiving time-of-arrival information from a plurality of network access point devices, wherein the time-of-arrival information describes at least one of the series of electromagnetic pulses.

8. The method of claim 7 further comprising determining a rate of travel of the network node, and wherein determining the direction of travel and rate of travel of the network node comprises determining the location of the network node at a different time.

9. The method of claim 1 wherein identifying a network access point to communicate with the network node comprises selecting from a plurality of network access points that can communicate with the network node.

10. The method of claim 9 wherein selecting from a plurality of network access points comprises selecting one or more network access points based on criteria that affect performance delivered to the network node.

11. A method comprising:
receiving wireless signals originating from a network node;
determining a location of the network node; and
receiving from the network node indications of signal quality for wireless signals received by the network node from a plurality of network access point devices.

12. The method of claim 11 further comprising adding the indications of signal quality to a data table describing coverage maps for each of the plurality of network access point devices.

13. The method of claim 11 further comprising:
determining a second location of the network node at a second time; and
receiving from the network node a second indication of signal quality for wireless signals received by the network node from the plurality of network access point devices.

14. The method of claim 11 further comprising:
determining locations of a plurality of network nodes;
receiving signal quality indications from the plurality of network nodes; and
adding the signal quality indications from the plurality of network nodes to the data table.

15. The method of claim 14 wherein determining locations of a plurality of network nodes comprises receiving pulse time-of-arrival information from the plurality of network access point devices and resolving the location of the plurality of network nodes.

16. The method of claim 14 wherein determining locations of a plurality of network nodes comprises receiving pulse angle-of-arrival information from the plurality of network access point devices and resolving the location of the plurality of network nodes.

17. A method comprising:
receiving wireless signals originating from a network node;
determining a location of the network node;
assessing signal quality of the wireless signals; and
adding indications of the signal quality to a data table describing coverage maps for each of a plurality of network access point devices.

18. The method of claim 17 further comprising:
determining locations of a plurality of network nodes;
assessing signal quality indications of wireless signals received from the plurality of network nodes; and
adding the signal quality indications from the plurality of network nodes to the data table.

19. The method of claim 18 wherein determining locations of a plurality of network nodes comprises receiving pulse time-of-arrival information from the plurality of network access point devices and resolving the location of the plurality of network nodes.

20. An article comprising a machine-accessible media having associated data, wherein the data, when accessed, results in a machine performing:
receiving an electromagnetic pulse transmitted from a transmitter in a network;
determining a location of the transmitter from an attribute describing the electromagnetic pulse; and
selecting one or more network access point devices to communicate with the transmitter.

21. The article of claim 20 wherein receiving an electromagnetic pulse comprises receiving an electromagnetic pulse from a network node.

22. The article of claim 21 further comprising determining a second location of the network node at a different time.

23. The article of claim 22 further comprising determining a direction of travel of the network node.

24. The article of claim 22 further comprising determining a velocity of the network node.

25. The article of claim 20 wherein selecting one or more network access point devices to communicate with the transmitter comprises selecting a network access point device using the location of the transmitter and a coverage map for a plurality of network access points.

26. A network comprising:
a plurality of network access point devices, each of the plurality of network access point devices including a receiver to receive wireless signals from a network node, and including a transmitter to transmit attributes of the wireless signals; and
a server coupled to the plurality of network access point devices to receive the attributes of the wireless signals, to determine a location of the network node, and to select one or more appropriate network access points from the plurality of network access point devices to communicate with the network node based on the location.

27. The network of claim 26 wherein each of the plurality of network access point devices is configured to receive pulsed wireless signals from the network node.

28. The network of claim 27 wherein each of the plurality of network access point devices further includes time-of-arrival detection circuitry to detect time-of-arrival of pulses as one of the attributes of the wireless signals.

29. The network of claim 28 wherein the server is configured to receive the time-of-arrival from each of the plurality of network access point devices and resolve the location of the network node.

30. The network of claim 27 wherein each of the plurality of network access point devices further includes angle-of-arrival detection circuitry to detect angle-of-arrival of pulses as one of the attributes of the wireless signals.

31. The network of claim 30 wherein the server is configured to receive the angle-of-arrival from each of the plurality of network access point devices and resolve the location of the network node.

32. The network of claim 26 wherein the server is configured to maintain a coverage map for the plurality of network access point devices, and is further configured to select the one or more appropriate network access point devices based at least in part on the coverage map.

33. A network server comprising at least one port to couple the network server to a plurality of wireless network access point devices, the network server being configured to receive wireless signal attributes from the plurality of wireless network access point devices, to determine a location of a transmitter from the wireless signal attributes, and to determine one or more appropriate network access point devices from the plurality of network access point devices to communicate with the transmitter.

34. The network server of claim 33 wherein the network server is further configured to receive time-of-arrival information from the wireless network access point devices.

35. The network server of claim 33 wherein the network server is further configured to receive angle-of-arrival information from the wireless network access point devices.

36. The network server of claim 33 wherein the network server is configured to determine a direction of travel of the transmitter.

37. The network server of claim 33 wherein the network server is configured to determine a velocity of the transmitter.

38. The network server of claim 33 wherein the network server is configured to maintain a coverage map for each of the plurality of network access point devices.
